(19) United States
(12) Patent Application Publication
(10) Pub. No.: US 2012/0037465 A1
(43) Pub. Date: Feb. 16, 2012

(54) BRAKING DEVICE AND METHOD FOR MANUFACTURING FRICTION MATERIAL

(75) Inventors: Kenji Abe, Toyota-shi (JP); Hiroshi Isono, Mishima-shi (JP); Yoshitomo Denou, Mishima-shi (JP)

(73) Assignee: TOYOTA JIDOSHA KABUSHIKI KAISHA, Toyota-shi (JP)

(21) Appl. No.: 13/141,610

(22) PCT Filed: Jun. 15, 2009
(86) PCT No.: PCT/JP2009/060868

§ 371 Date: Jun. 22, 2011

(51) Int. Cl. F16D 65/02; B27N 3/00; F16D 65/10; F16D 65/04; F16D 65/12

(52) U.S. Cl. 188/73.1; 156/62.2

(57) ABSTRACT

A braking device is provided with a pad having hard particles on a wavelike friction surface, and a disc having a hard layer on a wavelike friction surface which slides on the wavelike friction surface. The wavelike friction surface has a groove portion in a direction in which the wavelike friction surfaces slide on each other, and the wavelike friction surface has a protruding portion which abuts on the groove. Therefore, the actual contact area between the friction surfaces having the hard members is increased, and a higher frictional force can be obtained without sacrificing wear resistance.

### TECHNICAL FIELD

The present invention relates to a braking device and a method for manufacturing a friction material, and particularly, to a braking device provided with a pair of friction materials having a friction surface, and a method for manufacturing a friction material used for the braking device.

### BACKGROUND ART

A braking device consisting of a pad and a rotor (disc) of a conventional brake for an automobile is a combination of a relatively hard component and a relatively soft component. Therefore, the conventional braking device has a problem in that the effect of the brake is poor or either of the hard and soft components is apt to wear out. For example, in a braking device in which a non-steel pad consisting of a soft resin-based component, and a harder cast-iron rotor are combined together, and a frictional force is generated by adhesion friction, there is a problem in that the effect of the brake is poor. Additionally, in a braking device in which a low steel pad consisting of hard steel fibers, and a softer cast-iron rotor are combined together, and a frictional force is generated by abrasive friction, there is a problem in that there is a lot of wear on the rotor.

Thus, for example, Patent Literature 1 discloses a brake pad, which is manufactured by arranging and forming a composite material portion consisting of at least silicon carbide and metal silicon in a predetermined ratio and having excellent wear resistance, on the surface of a base material of a C/C composite which is a composite carbon fiber, a brake disc, and a brake consisting of the brake pad, in order to improve wear resistance.

### CITATION LIST

### Patent Literature

[Patent Literature 1] Japanese Unexamined Patent Application Publication No. 2002-257168

### SUMMARY OF INVENTION

### Technical Problem

In the braking device in which hard materials are arranged on both the pad and the disc as described above, there is an advantage that wear is very slight on both the pad and the disc. However, in the braking device in which hard materials are arranged on both the pad and the disc as described above, the frictional force (frictional coefficient) between the pad and the disc is not necessarily made to be high.

The invention has been made in consideration of such circumstances, and the object thereof is to provide a braking device and a method for manufacturing a friction material which can obtain a higher frictional force, without sacrificing wear resistance.

### Solution to Problem

The invention is a braking device including a first friction material having a first hard member on a first friction surface; and a second friction material having a second hard member on a second friction surface which moves with respect to the first friction surface. Any one of the first hard member and the second hard member includes a groove portion along a movement direction of the second friction surface with respect to the first friction surface. The other one of the first hard member and the second hard member includes a protruding portion which abuts on the groove portion.

According to this configuration, in a braking device including a first friction material having a first hard member on a first friction surface; and a second friction material having a second hard member on a second friction surface which moves with respect to the first friction surface, any one of the first hard member and the second hard member includes a groove portion along a movement direction of the second friction surface with respect to the first friction surface, and the other one of the first hard member and the second hard member includes a protruding portion which abuts on the groove portion. Therefore, the actual contact area between the friction surfaces having the hard members is increased, and a higher frictional force can be obtained without sacrificing wear resistance.

In this case, preferably, a force acting on an abutting portion between the groove portion and the protruding portion includes a component in a direction which is perpendicular to the movement direction of the second friction surface with respect to the first friction surface and parallel to either the first friction surface or the second friction surface.

According to this configuration, a force acting on an abutting portion between the groove portion and the protruding portion includes a component in a direction which is perpendicular to the movement direction of the second friction surface with respect to the first friction surface and parallel to either the first friction surface or the second friction surface. Therefore, the force acting per unit area of the abutting portion between the groove portion and the protruding portion becomes the same as that of the conventional flat friction surface due to the resultant force with the force of the component (a force which presses the first friction material and the second friction material against each other) in the direction perpendicular to the movement direction of the second friction surface with respect to the first friction surface and perpendicular to any of the first friction surface and the second friction surface. As a result, the area of the abutting portion increases, so that a higher frictional force can be obtained.

Additionally, it is preferable that any one of the first hard member and the second hard member includes a plurality of the groove portions, and the other one of the first hard member and the second hard member includes protruding portions which abut the plurality of groove portions, respectively.

According to this configuration, any one of the first hard member and the second hard member includes a plurality of the groove portions, and the other one of the first hard member and the second hard member includes protruding portions which abut the plurality of groove portions, respectively. Therefore, a higher frictional force can be obtained by the plurality of groove portions and protruding portions.

Additionally, it is preferable that the groove portion and the protruding portion form wavelike shapes which abut on each other, in a sectional view through a section perpendicular to the movement direction of the second friction surface with respect to the first friction surface.

According to this configuration, the groove portion and the protruding portion form wavelike shapes which abut on each other, in a sectional view through a section perpendicular to the movement direction of the second friction surface with respect to the first friction surface. Therefore, the actual contact area between the frictional surfaces is increased, and a higher frictional force can be obtained.

In this case, preferably, the groove portion and the protruding portion form wavelike shapes having mutually different amplitudes, in a sectional view through a section perpendicular to the movement direction of the second friction surface with respect to the first friction surface.

According to this configuration, the groove portion and the protruding portion form wavelike shapes having mutually different amplitudes, in a sectional view through a section perpendicular to the movement direction of the second friction surface with respect to the first friction surface. Therefore, places where the groove portion and the protruding portion abut on each other are limited. Therefore, the actual contact area between the friction surfaces can be stabilized, and a stable frictional force can be obtained.

Additionally, it is preferable that the protruding portion consists of a spherical body and a portion of the spherical body.

According to this configuration, the protruding portion consists of a spherical body and a portion of the spherical body. Therefore, places where the groove portion and the protruding portion abut on each other are limited. Therefore, the actual contact area between the friction surfaces can be stabilized, and a stable frictional force can be obtained.

In this case, preferably, the groove portion forms a V shape which abuts on the spherical body of the protruding portion at two points, in a sectional view through a section perpendicular to the movement direction of the second friction surface with respect to the first friction surface.

According to this configuration, the groove portion forms a V shape which abuts on the spherical body of the protruding portion at two points, in a sectional view through a section perpendicular to the movement direction of the second friction surface with respect to the first friction surface. Therefore, places where the groove portion and the protruding portion abut on each other are further limited. Therefore, the actual contact area between the friction surfaces can be further stabilized, and a more stable frictional force can be obtained.

Additionally, as the second friction material rotates, the second friction surface may move with respect to the first friction surface.

According to this configuration, the braking device of the invention can be applied to an automobile, for example, using the first friction material as a brake pad and using the second friction material as a brake disc or a brake drum.

Additionally, it is preferable that at least any one of the first hard member and the second hard member includes a foreign matter removing portion which discharges foreign matter which has entered between the groove portion and a recessed portion.

According to this configuration, at least any one of the first hard member and the second hard member includes a foreign matter removing portion which discharges foreign matter which has entered between the groove portion and a recessed portion. Therefore, even in prolonged use, the foreign matter which has entered between the groove portion and the recessed portion can be discharged, and a stable frictional force can be obtained.

Additionally, it is preferable that the first hard member and the second hard member are made of any of a material of a hardness at which wear does not occur when the second friction surface moves with respect to the first friction surface and a material with a Mohs hardness which is greater than or equal to 9.

According to this configuration, the first hard member and the second hard member are made of any of a material of a hardness at which wear does not occur when the second friction surface moves with respect to the first friction surface and a material with a Mohs hardness which is greater than or equal to 9. Therefore, the wear resistance of the friction material can be enhanced.

Additionally, it is preferable that the first hard member and the second hard member are made of either the same material or materials having the same Mohs hardness.

According to this configuration, the first hard member and the second hard member are made of either the same material or materials having the same Mohs hardness. Therefore, the first hard member and the second hard member are mutually resistant to wear, and the wear resistance of the friction material can be enhanced.

Meanwhile, the invention is a method for manufacturing a first friction material in a friction material for braking including the first friction material having a first hard member on a first friction surface; and a second friction material having a second hard member on a second friction surface which moves with respect to the first friction surface. The second hard member includes a groove portion along a movement direction of the second friction surface with respect to the first friction surface, and the first hard member includes a protruding portion which abuts on the groove portion. The method includes arranging spherical hard members on the first friction surface so as to make rows along the movement direction of the second friction surface with respect to the first friction surface; and fixing the hard member to the first friction surface.

According to this configuration, in a method for manufacturing a first friction material in a friction material for braking including the first friction material having a first hard member on a first friction surface; and a second friction material having a second hard member on a second friction surface which moves with respect to the first friction surface, the second hard member includes a groove portion along a movement direction of the second friction surface with respect to the first friction surface, and the first hard member includes a protruding portion which abuts on the groove portion. The method includes arranging spherical hard members on the first friction surface so as to make rows along the movement direction of the second friction surface with respect to the first friction surface; and fixing the hard member to the first friction surface. Therefore, a desired friction material can be manufactured with comparative ease and at low cost.

Additionally, the invention is a method for manufacturing a second friction material in a friction material for braking including a first friction material having a first hard member on a first friction surface; and the second friction material having a second hard member on a second friction surface which moves with respect to the first friction surface. The second hard member includes a groove portion along a movement direction of the second friction surface with respect to the first friction surface, and the first hard member includes a protruding portion which abuts on the groove portion. The method includes arranging a grinding member capable of grinding the second hard member at the same position as the protruding portion of the first friction material instead of the protruding portion of the first friction material; and moving the second friction surface with respect to the first friction surface along a movement direction of the second friction surface with respect to the first friction surface, thereby grinding the second hard member with the grinding member.

According to this configuration, in a method for manufacturing a second friction material in a friction material for braking including a first friction material having a first hard member on a first friction surface; and the second friction material having a second hard member on a second friction surface which moves with respect to the first friction surface, the second hard member includes a groove portion along a movement direction of the second friction surface with respect to the first friction surface, and the first hard member includes a protruding portion which abuts on the groove portion. The method includes arranging a grinding member capable of grinding the second hard member at the same position as the protruding portion of the first friction material instead of the protruding portion of the first friction material; and moving the second friction surface with respect to the first friction surface along a movement direction of the second friction surface with respect to the first friction surface, thereby grinding the second hard member with the grinding member. Therefore, the groove portion of the second friction surface can be manufactured in the state where the groove portion corresponds to the protruding portion of the first friction material with higher precision.

### Advantageous Effects of Invention

According to the braking device of the invention, a high frictional force can be obtained without sacrificing wear resistance, and according to the method for manufacturing a friction material of the invention, a friction material which can obtain a higher frictional force can be manufactured without sacrificing wear resistance.

### BRIEF DESCRIPTION OF DRAWINGS

FIG. 1 is a perspective view showing a pad and a disc related to a first embodiment.

FIG. 2 is a sectional view taken along a line A-A of FIG. 1 in the pad and disc related to the first embodiment.

FIG. 3X is a sectional view showing a force which acts on the friction surface of a conventional disc, and FIG. 3Y is a sectional view showing a force which acts on the friction surface of a disc of the present embodiment.

FIG. 4 is a sectional view taken along the line A-A of FIG. 1 in a pad and a disc related to a second embodiment.

FIG. 5 is a sectional view taken along the line A-A of FIG. 1 in a pad and a disc related to a third embodiment.

FIG. 6 is a perspective view showing a pad and a disc related to a fourth embodiment.

FIG. 7 is a sectional view taken along the line A-A of FIG. 1 in a pad and a disc related to a fifth embodiment.

FIG. 8 is an enlarged view of FIG. 7.

FIGS. 9X and 9Y are views showing a manufacturing process of the pad of the fifth embodiment.

FIG. 10 is a perspective view showing forces which are applied to a conventional pad and disc.

FIG. 11 is a view showing a force which is applied to the conventional pad.

FIG. 12 is a view showing a force which is applied to the conventional pad.

FIG. 13 is a perspective view showing forces which are applied to the pad and disc of the first embodiment.

FIG. 14 is a view showing a force which is applied to the pad of the first embodiment.

FIG. 15 is a perspective view showing a pad and a disc related to a sixth embodiment.

FIG. 16 is a perspective view showing a pad and a disc related to a seventh embodiment.

FIG. 17 is a perspective view showing a manufacturing process of a pad of an eighth embodiment.

FIG. 18 is a perspective view showing the manufacturing process of the pad of the eighth embodiment.

FIG. 19 is a perspective view showing the manufacturing process of the pad of the eighth embodiment.

FIG. 20 is a perspective view showing a friction surface of the pad of the eighth embodiment.

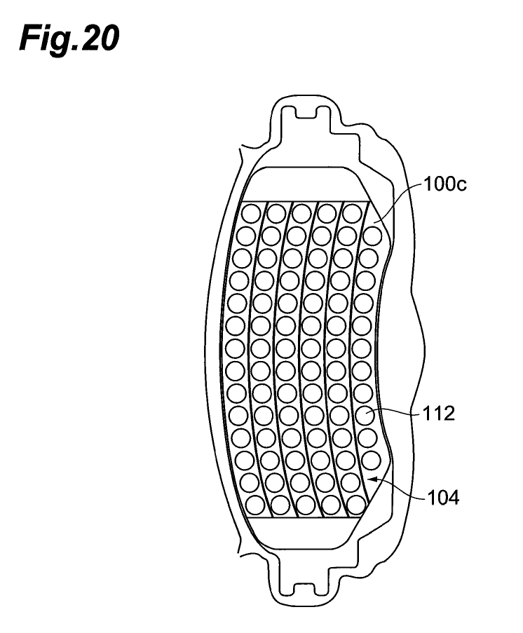

FIG. 21 is a flow diagram showing a manufacturing process of a disc related to a ninth embodiment.

FIG. 22 is a perspective view showing a grinding instrument related to the ninth embodiment.

FIG. 23 is a flow diagram showing a manufacturing process of a disc related to a tenth embodiment.

FIG. 24 is a perspective view showing a pad and a drum related to an eleventh embodiment.

### DESCRIPTION OF EMBODIMENTS

Hereinafter, a braking device and a method for manufacturing a friction material related to embodiments of the invention will be described with reference to the drawings.

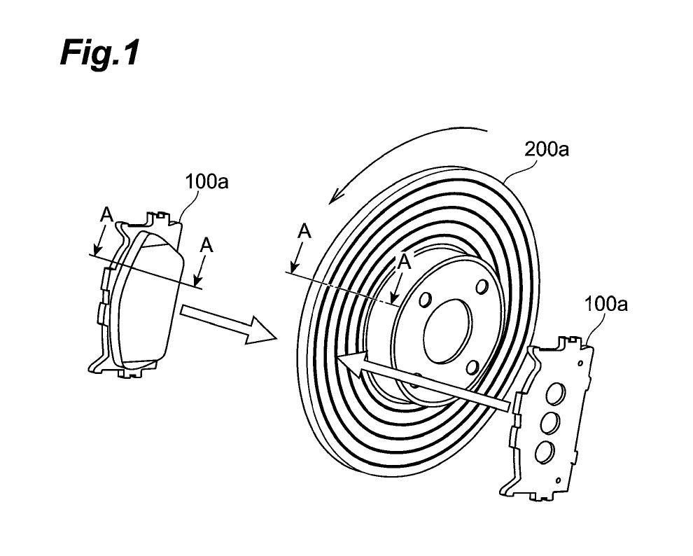

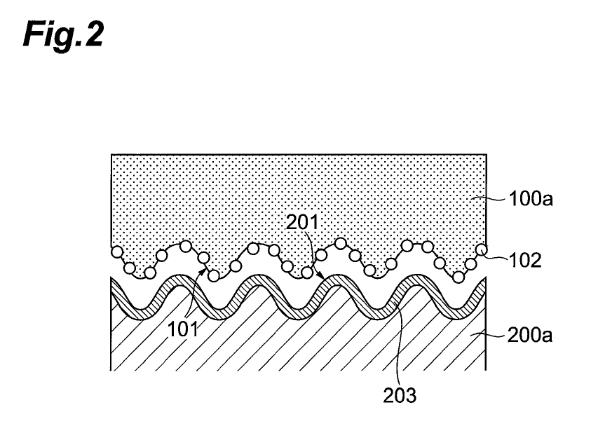

In the first embodiment of the invention, the braking device related to the invention is applied to a disc brake of an automobile. As shown in FIG. 1, the disc brake generates a frictional force as two pads 100a are pressed against both sides of a disc 200a which rotates. As shown in FIG. 2, the pad 100a has a wavelike friction surface 101, in a sectional view (sectional view in the line A-A of FIG. 1) in a plane perpendicular to the rotational direction of the disc 200a. The disc 200a has a wavelike friction surface 201 corresponding to the wavelike friction surface 101 of the pad 100a. Therefore, as shown in FIG. 1, the disc 200a has a shape in which wavelike grooves are provided in concentric circles, on both sides thereof. In addition, the wavelike friction surfaces 101 and 201 can be formed into any shape of a sinusoidal wave and a saw-tooth wave in a sectional view in a plane perpendicular to the rotational direction of the disc 200a.

Hard particles 102 made of ceramics, such as Si₃N₄, Al₂O₃, and ZrO₂, are embedded in the wavelike friction surface 101 of the pad 100a. The diameter of the hard particles 102 is 0.1 mm to several millimeters. Additionally, the surface layer portion of the wavelike friction surface 201 of the disc 200a has a hard layer 203 formed through a nitriding treatment by thermal spraying or the like, adhesion, or the like. The wavelength and amplitude of the wavelike friction surfaces 101 and 201 are such that one or more hard particles 102 enter, and are about 0.1 mm to 5 mm It is preferable that the hard particles 102 of the pad 100a and the hard layer 203 of the disc 200a have the hardness at which wear does not occur at the time of braking, or a Mohs hardness greater than or equal to 9. Additionally, it is preferable that the hard particles 102 of the pad 100a and the hard layer 203 of the disc 200a be made of the same kind of material, or made of materials having the same Mohs hardness.

Hereinafter, the working effects of the braking device of the present embodiment will be described. Generally, two kinds of factors of adhesion friction and thermal conversion by attenuation have a great influence on a dry-friction phenomenon between hard members with little difference in hardness. In addition, the above-described abrasive friction is a principle that one hard friction material shaves off another softer friction material, and has little influence on the dry-friction phenomenon between hard members with little hardness difference.

The adhesion friction is based on an attractive force acting between the substances of hard members, for example, an intermolecular force. The frictional force due to the adhesion friction depends greatly on (1) the magnitude of an intermolecular force depending on the crystal structure or the like of a substance itself, (2) the distance (as the distance is shorter, the frictional force is larger) between substances (for example, molecules), and (3) the actual contact area between hard members. As for the actual contact area of (3), that the distance between substances (for example, molecules) of hard members is short in many portions means that the actual contact area is large, and the frictional force is increased.

However, even if the area of a pad is simply increased in a disc brake, since the pressing force (pressure) per unit area decreases if the force from a piston which pushes the pad against a disc is the same, the frictional force does not increase. Thus, in the present embodiment, the friction surfaces of the pad 100a and the disc 200a are made into the wavelike friction surfaces 101 and 201, respectively. Thereby, even when the force from the piston is the same, the actual contact area is increased such that the pressing force per unit area does not change.

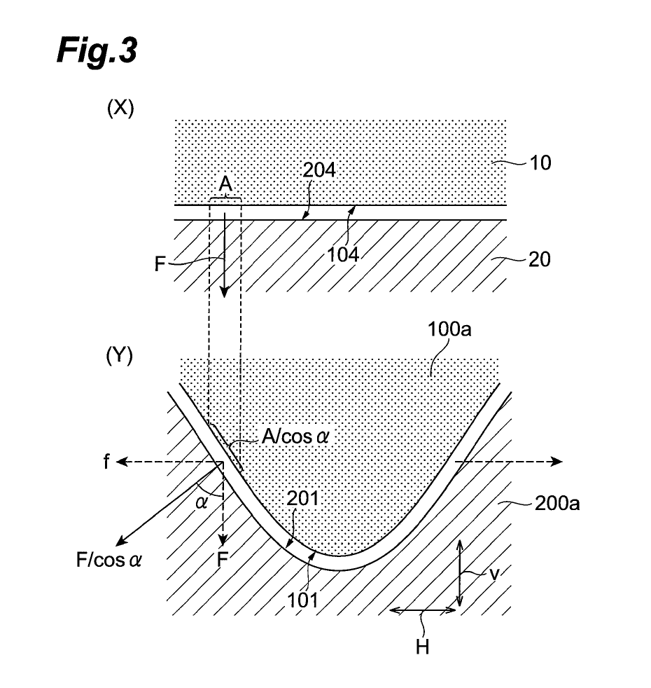

As shown in FIG. 3X, in a pad 10 and a disc 20 which have conventional flat friction surfaces 104 and 204, respectively, the force with which the pad 10 pushes the disc 20 in a perpendicular direction V of the friction surfaces becomes F per unit area A. On the other hand, as shown in FIG. 3Y, in the pad 100a and the disc 200a of the present embodiment, the area of the unit area A projected on the wavelike friction surfaces 101 and 201 is A/cos α. Here, α is an angle that the normal of the wavelike friction surfaces 101 and 201 makes with the perpendicular direction V.

If the force (pushing force of the piston) with which the overall pad 100a pushes the disc 200a in the perpendicular direction V is not different from the force in which the overall pad 10 pushes the disc 20 in the perpendicular direction V, the component of a force which acts in the perpendicular direction V of a portion whose area is A/cos α is similarly F. At this time, in the wavelike friction surfaces 101 and 201, the component of a force which acts in a direction H parallel to the friction surfaces causes a reaction force f between the wavelike friction surfaces 101 and 201, thereby achieving a balance. Accordingly, the load of the portion whose area is A/cos α in a direction truly perpendicular to the wavelike friction surfaces 101 and 201 becomes a resultant force of F and f, and becomes F/cos α.

In this case, since the force acting on the area A/cos α becomes F/cos α, the force per the unit area A is F, and becomes the same as for the pad 10 and disc 20 which have the conventional flat friction surfaces 104 and 204, respectively. Accordingly, in the pad 100a and the disc 200a of the present embodiment, since the actual contact area is increased by the wavelike friction surfaces 101 and 201 irrespective of whether the pressing force per unit area remains unchanged, the frictional force can be increased.

In the present embodiment, in the braking device including the pad 100a having the hard particles 102 on the wavelike friction surface 101, and the disc 200a having the hard layer 203 on the wavelike friction surface 201 which slides on the wavelike friction surface 101, the wavelike friction surface 201 has groove portions along a sliding direction between the wavelike friction surfaces 101 and 201, and the wavelike friction surface 101 has protruding portions which abut on the grooves. Therefore, the actual contact area between the friction surfaces having the hard members is increased, and a higher frictional force can be obtained without sacrificing wear resistance.

Additionally, in the present embodiment, the abutting area between the wavelike friction surfaces 101 and 201 increases compared to the conventional flat friction surface 104 and 204. In addition, since the force f of the component in the direction H parallel to the wavelike friction surfaces 101 and 201 is included in the force acting on the abutting portion between the wavelike friction surfaces 101 and 201, the force acting per unit area of the abutting portion between the wavelike friction surfaces 101 and 201 becomes the same due to the resultant force with the force F of the component in the direction V perpendicular to the wavelike friction surfaces 101 and 201. As a result, a higher frictional force can be obtained.

Additionally, in the present embodiment, since the wavelike friction surfaces 101 and 201 have a plurality of groove portions and protruding portions and abut on each other, a higher frictional force can be obtained. Particularly, in the present embodiment, the wavelike friction surfaces 101 and 201 form wavelike shapes which abut on each other, in a sectional view through a section perpendicular to the direction of sliding between the wavelike friction surfaces 101 and 201. Therefore, the actual contact area between the friction surfaces is increased, and a higher frictional force can be obtained. In addition, in the present embodiment, a braking device for an automobile including the pad 100a and the disc 200a can be provided.

Additionally, in the present embodiment, the hard particles 102 and the hard layer 203 are made of any of a material of a hardness at which wear does not occur at the time of braking and a material with a Mohs hardness which is greater than or equal to 9. Therefore, the wear resistance of the friction material can be enhanced. Additionally, in the present embodiment, the hard particles 102 and the hard layer 203 are made of any of the same material and materials having the same Mohs hardness. Therefore, the hard particles and the hard layer are mutually resistant to wear, and the wear resistance of the friction material can be enhanced.

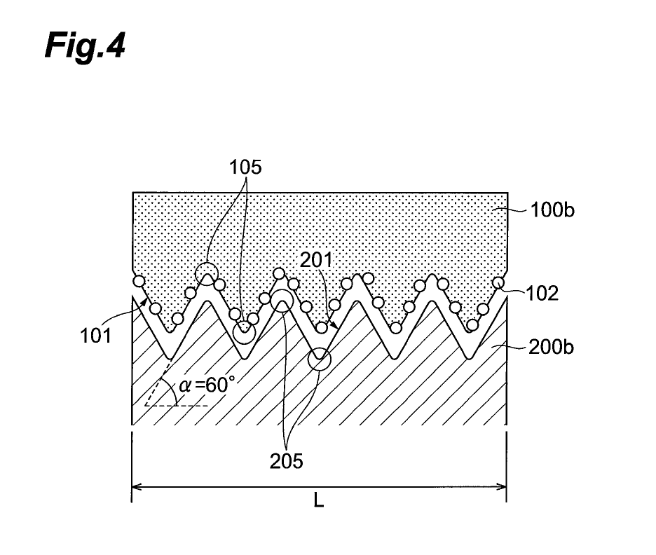

Additionally, by setting the depth of the wavelike friction surfaces 101 and 201 shown in FIG. 3Y to 0.5 mm to 1.5 mm, and satisfying α=60°, a double frictional force is obtained on the whole compared to the flat friction surface 104 and 204 shown in FIG. 3X. As shown in a pad 100b and a disc 200b of a second embodiment of FIG. 4, in the case of α=60°, the pushing force per unit area A is F, and the frictional coefficient μ is the same as the conventional one. In this case, as for the frictional force in the length L perpendicular to the rotational direction of the disc, the frictional force in the flat friction surface 104 and 204=μF/A×L=μL/A is obtained, whereas the frictional force in the wavelike friction surfaces 101 and 201=μF/A×L/cos 60°=2 μL/A. As a result, a double frictional force can be obtained.

In addition, as shown in FIG. 4, in order to prevent the wavelike friction surfaces 101 and 201 from not separating from each other when biting into each other, it is preferable to provide R portions 105 and 205 at angled portions of the wavelike friction surfaces 101 and 201, respectively. Since the frictional force decreases at the R portions 105 and 205, it is preferable that the size of the R portions 105 and 205 be a requisite minimum. Specifically, it is preferable that the radius of curvature of the R portions 105 and 205 be greater than the radius of the hard particles 102. It is more preferable that the radius of curvature of the R portions 105 and 205 be 1.5 or more times the radius of the hard particles 102.

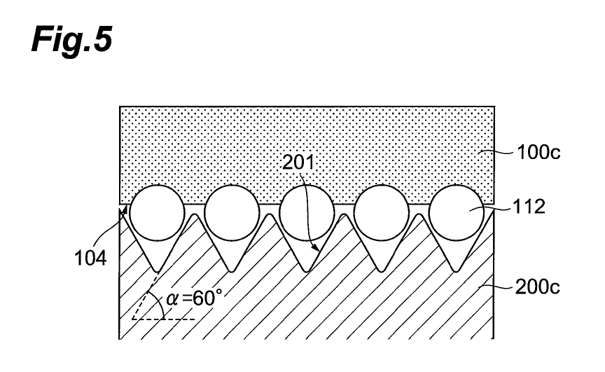

Hereinafter, a third embodiment of the invention will be described. As shown in FIG. 5, in the present embodiment, spherical hard particles 112 of such a size that the hard particles exactly enter and abut on groove portions, respectively, of a wavelike friction surface 201 of a disc 200c are arranged in a flat friction surface 104 of a pad 100c. The spherical hard particles 112 are arranged so as to be aligned along the grooves of the wavelike friction surface 201 of the disc 200c. It is preferable that the wavelike friction surface of the disc 200c assumes a sawtooth wave shape in a sectional view in a plane perpendicular to the rotational direction of the disc 200c. Similarly to the above first embodiment, by setting the angle α of the wavelike friction surface 201 to 60°, a double frictional force can be obtained compared to a case where the hard particles 112 of the same number are arranged in the conventional flat friction surface 104, and are made to abut on the disc 20 having the flat friction surface 204.

In the present embodiment, each of the hard particles 112 arranged in the flat friction surface 104 of the pad 100c necessarily touches the wavelike friction surface 201 with a sawtooth wave shape

(V-shape), of the disc 200c at two points. Therefore, the overall pad 100c stably touches the disc 200c at points of twice the number of the hard particles 112. Therefore, it is possible to stabilize a frictional force.

Particularly, in the present embodiment, the wavelike friction surface 201 of the disc 200c forms a V shape which abuts on the spherical hard particles 112 at two points, in a sectional view through a section perpendicular to the direction of sliding between the flat friction surface 104 and the wavelike friction surface 201. Therefore, places where the hard particles 112 and the wavelike friction surface 201 abut on each other are further limited. Therefore, the actual contact area between the friction surfaces can be further stabilized, and a more stable frictional force can be obtained.

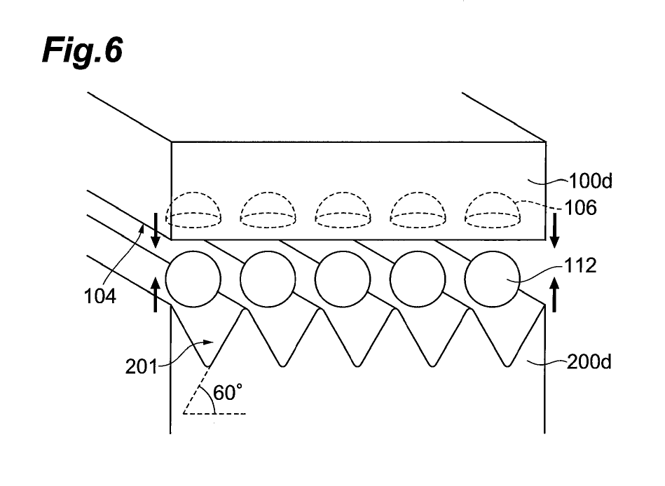

Additionally, in a pad 100d and a disc 200d of a fourth embodiment shown in FIG. 6, the hard particles 112 are not fixed to the pad 100d side. In the present embodiment, hemispherical or conical hole portions 106 of a size which is slightly greater than or slightly smaller than the hard particles 112 are provided on the pad 100d side. The hard particles 112 are sandwiched between the hole portions 106 of the pad 100d and the wavelike friction surface 201 of the disc 200d. In the present embodiment, there is an advantage that it is not necessary to take fixation of the hard particles 112 to the pad 100d or separation of the hard particles 112 from the pad 100d into consideration.

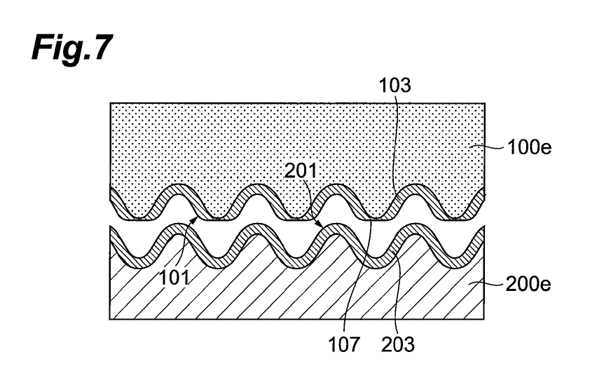

Hereinafter, a fifth embodiment of the invention will be described. As shown in FIG. 7, in the present embodiment, a wavelike friction surface 101 of a pad 100e and a wavelike friction surface 201 of a disc 200e form wavelike shapes having mutually different amplitudes, in a sectional view through a section perpendicular to the direction of sliding between the wavelike friction surfaces 101 and 201. That is, in the present embodiment, the concavo-convex shape of the wavelike friction surfaces 101 and 201 is slightly changed on the pad 100e side and the disc 200e side. The curvature of apex portions 107 of the wavelike friction surface 101 of the pad 100e is made smaller than that of groove portions of the wavelike friction surface 201 of the disc 200e. Hard layers 103 and 203 formed by a nitriding treatment through thermal spraying or the like, adhesion, or the like are provided in the surface layer portions of the wavelike friction surfaces 101 and 201.

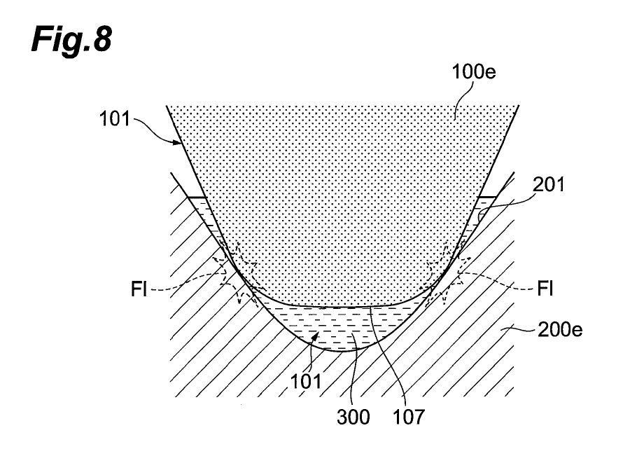

As shown in FIG. 8, in a sectional view through a section perpendicular to the direction of sliding between the wavelike friction surfaces 101 and 201, the wavelike friction surfaces 101 and 201 come into contact with each other at two frictional force generating portions F1 for every irregularity. At least one of the wavelike friction surfaces 101 and 201 has the structure in which the hard layers 103 or 203 of such a thickness that at least a portion can be elastically deformed are formed on the surface of an elastic body. Lubricant 300 is interposed between the wavelike friction surfaces 101 and 201.

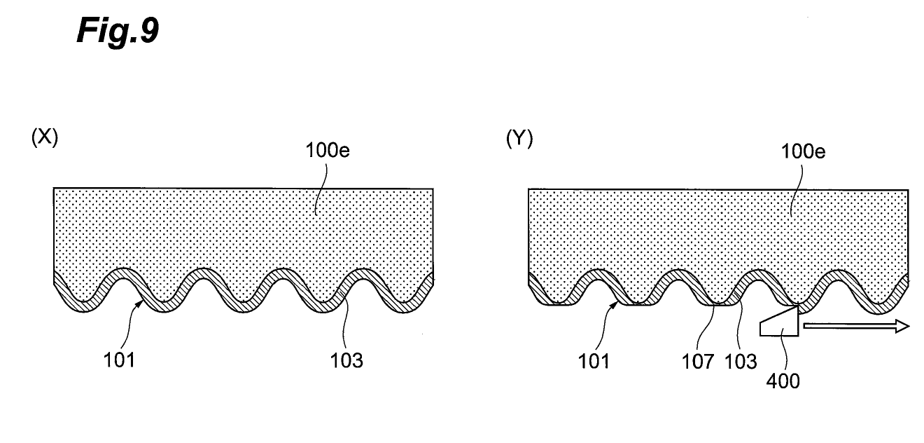

When the above pad 100e is manufactured, as shown in FIG. 9X, the same wavelike friction surface 101 as the wavelike friction surface 201 of the disc 200e is formed on the pad 100e. The hard layer 103 is provided on the wavelike friction surface 101 with equal thickness by a technique, such as a nitriding treatment through thermal spraying, adhesion, or the like. Next, as shown in FIG. 9Y, by grinding the hard layer 103 at the apex portions 107 by a grinding instrument 400, it is possible to manufacture the pad 100e which has the wavelike friction surface 101 having concavo-convex shape which is different from that of the wavelike friction surface 201 of the disc 200e.

In the present embodiment, the wavelike friction surface 101 of the pad 100e and the wavelike friction surface 201 of the disc 200e form wavelike shapes having mutually different amplitudes, in a sectional view in a section perpendicular to the direction of sliding between the wavelike friction surfaces 101 and 201. Therefore, places where the wavelike friction surfaces 101 and 201 abut on each other are limited. Therefore, the actual contact area between the wavelike friction surfaces 101 and 201 can be stabilized, and a stable frictional force can be obtained. Additionally, in the present embodiment, since the distance between the wavelike friction surfaces 101 and 201 is stable, a stable frictional force can be obtained. Moreover, the pad 100e and the disc 200e of the present embodiment have also an advantage of being comparatively easy to manufacture.

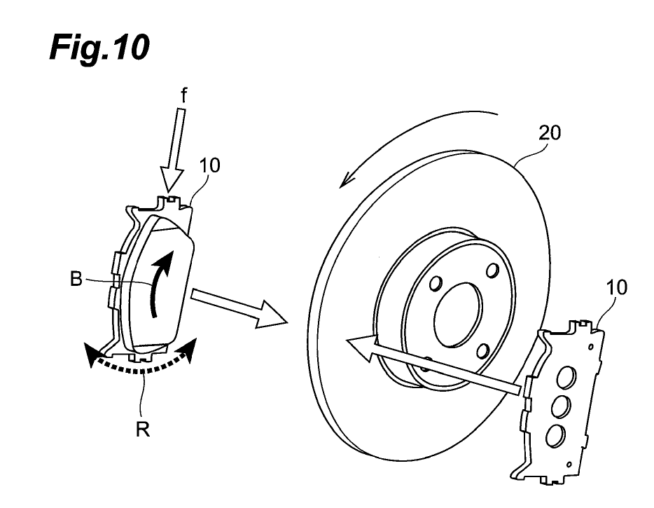

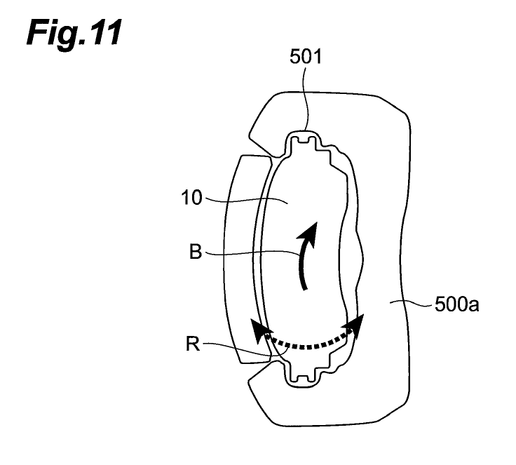

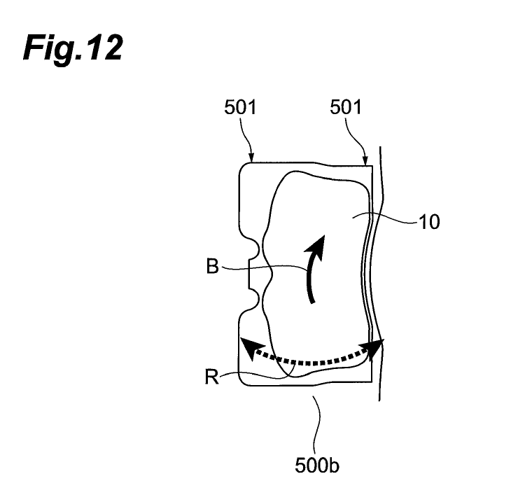

The braking devices of the above first to fifth embodiments exhibit further secondary effects. As shown in FIG. 10, in the pad 10 and disc 20 which have the conventional flat friction surface 104 and 204, a rotational force R to rotate the pad 10 in the radial direction of the disc 20 acts from an action between a braking force B and a reaction force f at a reaction force receiving portion of a caliper at the time of braking. For example, even in a case where the number of reaction force receiving portions 501 of a caliper 500a is one as shown in FIG. 11, and even in a case where the number of the reaction force receiving portions 501 of a caliper 500b is two as shown in FIG. 12, the rotational force R acts on the pad 10 similarly.

This rotational force R is an unstable force which fluctuates, for example, at the time of turning of an automobile, or due to the partial wear or the like influenced by the traveling history. Therefore, the contact state of a portion of suppressing the rotation of the pad 10 changes unstably between the calipers 500a and 500b and the pad 10. When the contact state between the calipers 500a and 500b and the pad 10 changes in this way, the resonant frequency tuned for a reduction in squeaking (key sound: squeal) may change, and squeaking may be generated.

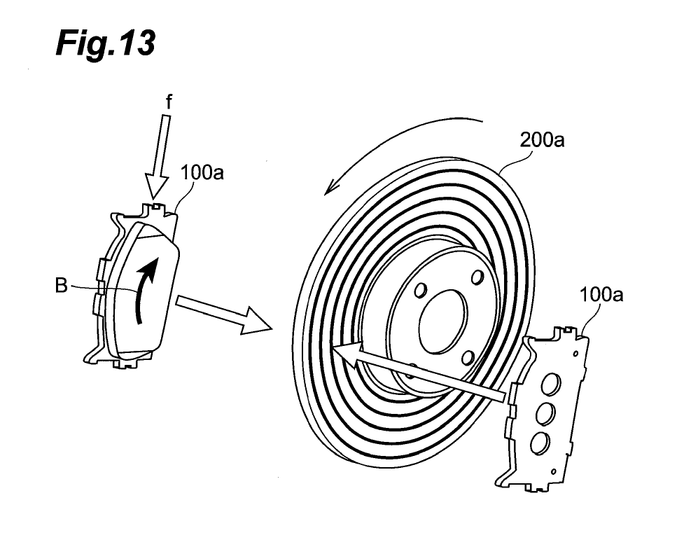

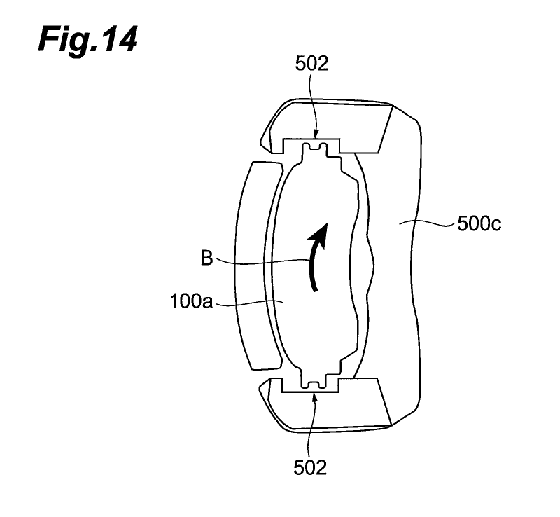

On the other hand, as shown in FIG. 13, in the above first embodiment, the pad 100a and the disc 200a include the wavelike friction surfaces 101 and 201 with little wear, and the rotational force R as in the conventional pad 10 does not act on the pad 100a. Therefore, in the above first embodiment, as shown in FIG. 14, the reaction force receiving portion 501 is eliminated from a caliper 500c, and a floating receiving portion 502 which does not constrain the pad 100a in the radial direction of the disc 200a is used.

Although the floating receiving portion 502 is a recessed portion with a large clearance from the pad 100a for preventing the pad 100a from coming off the caliper 500c, during normal use, there is no case where the pad 100a moves in the radial direction of the disc 200a, and comes into contact with side faces of the recessed portion of the floating receiving portion 502. That is, the side faces of the recessed portion of the floating receiving portion 502 do not function during normal use, but function to prevent the pad 100a from coming off only at the time of abnormality such that the pad 100a may come off.

As described, in the braking devices of the first to fifth embodiments, the load of the floating receiving portion 502 may change due to the braking forces B. However, since a place where the contact state between the caliper 500c and the pad 100a changes according to conditions is eliminated, a state where the performance of preventing squeaking has been tuned does not change. As a result, in the braking devices of the first to fifth embodiments, it is difficult for squeaking to be generated.

Hereinafter, sixth and seventh embodiments of the invention will be described. When the wavelike friction surface 201 of the disc 200a or the like is clogged with foreign matter, such as dust, the wavelike friction surface 101 of the pad 100a or the like will ride on the foreign matter. Therefore, a decrease in the actual contact area may decrease or the distance between the pad 100a and the disc 200a may increase. As a result, there is a possibility that a desired braking force is not obtained.

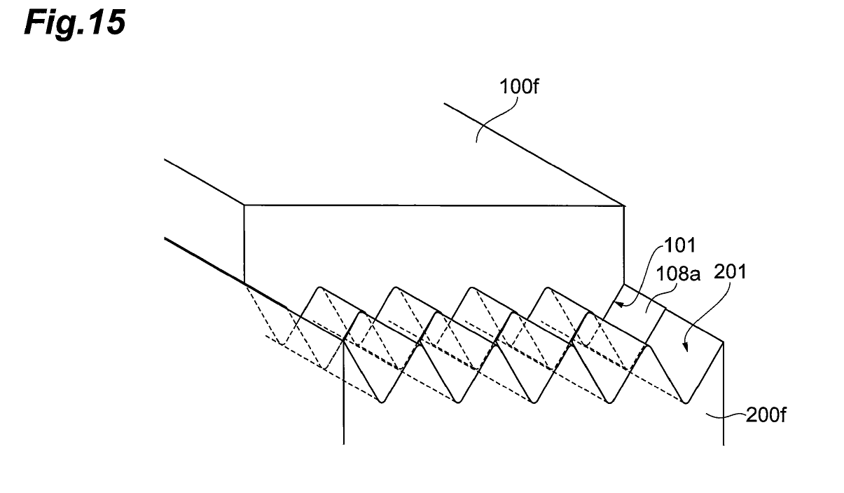

Thus, as shown in FIG. 15, in the present embodiment, the end of a pad 100f in the sliding direction is provided with a scraper 108a which protrudes along the shape of the wavelike friction surface 201 and which can peel off the foreign matter adhering to the wavelike friction surface 201 from the wavelike friction surface 201. In the present embodiment, the foreign matter which clogs the wavelike friction surface 201 of the disc 200f can be removed above the wavelike friction surface 201 of the disc 200f by the scraper 108a during rotation of the disc 200f.

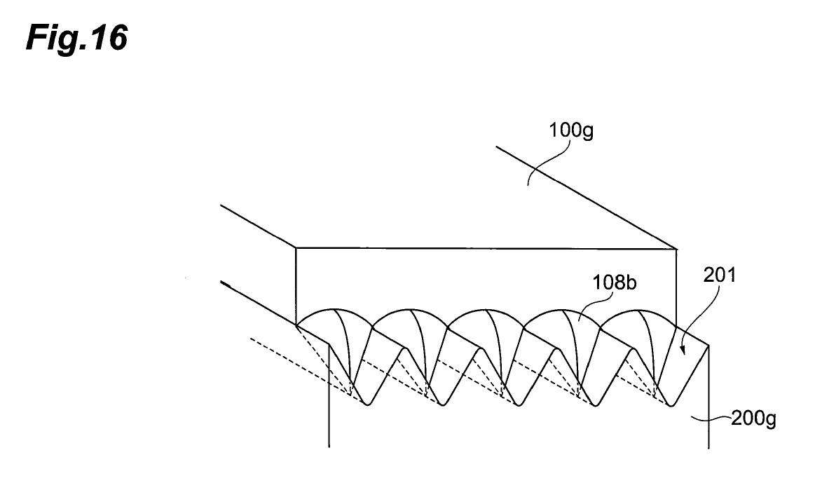

Additionally, in a pad 100g of a seventh embodiment shown in FIG. 16, the end of the pad 100g in the sliding direction is provided with a scraper 108b which protrudes along the shape of the wavelike friction surface 201 and which can scrape off the foreign matter which clogs the wavelike friction surface 201 in a direction parallel to the wavelike friction surface. In the present embodiment, the foreign matter which clogs the wavelike friction surface 201 of the disc 200g can be scraped off and removed in the direction parallel to the wavelike friction surface 201 of the disc 200g by the scraper 108b during rotation of the disc 200g.

According to the above sixth and seventh embodiments, since the scraper 108a or 108b for discharging the foreign matter which has entered between the wavelike friction surfaces 101 and 201 is included in the pads 100f or 100g, even in prolonged use, the foreign matter which has entered between the wavelike friction surfaces 101 and 201 can be discharged, and a stable frictional force can be obtained.

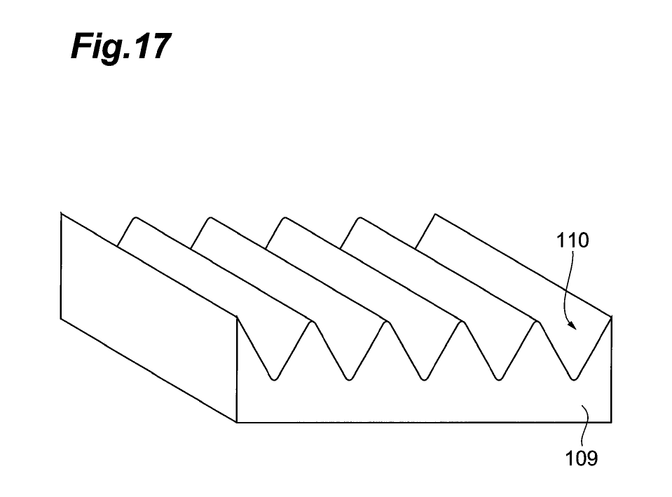

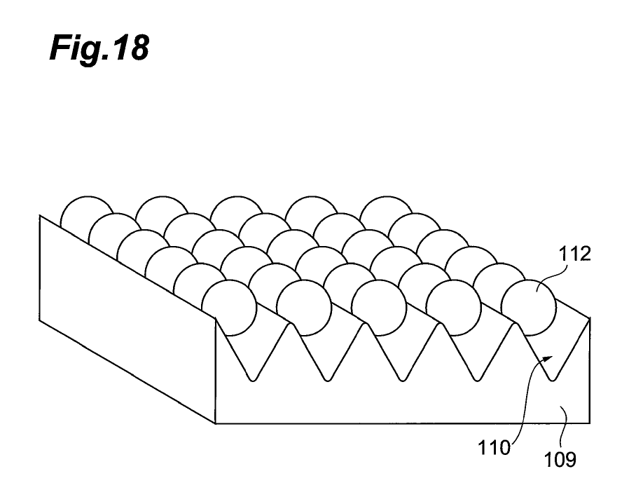

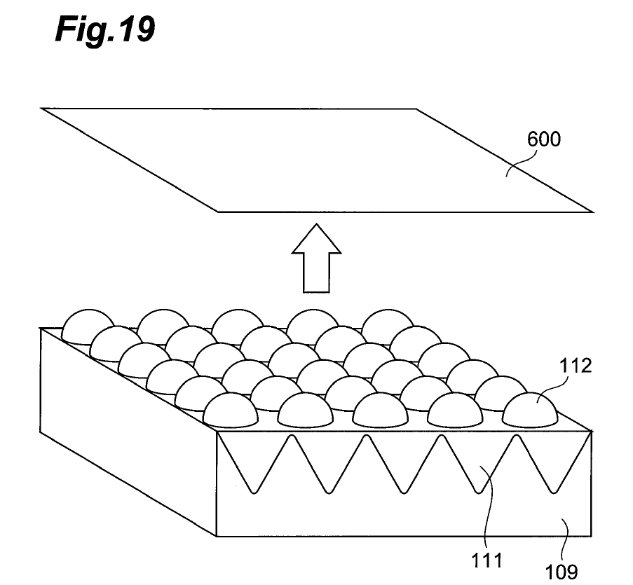

Hereinafter, a method for manufacturing the pad 100c of the above third embodiment in an eighth embodiment of the invention will be described. As shown in FIG. 17, first, a base 109 in which the groove portions of the wavelike friction surface 201 on the disc 200c side become the groove portions 110 is fabricated in accordance with the concentric wavelike friction surface 201 on the disc 200c side. Next, as shown in FIG. 18, the hard particles 112 are arranged side by side in the groove portions 110 of the base 109. Next, as shown in FIG. 19, resin (an admixture having a resin-based organic ingredient of 50% or more) 111 is made to flow into the groove portions 110. A jig 600 for improving dimensional precision is pressed against hard particles 112, and is fixed thereto.

In practice, the hard particles 112 are arranged in the flat friction surface 104 of the pad 100c so as to be aligned on the circles with the same curvature as the concentric circles of the wavelike friction surface 201 on the disc 200c side. Additionally, in the process of FIG. 19, the distance between the base 109 and the hard particles 112 can be controlled by controlling the distance between the jig 600 and the base 109 and press-fitting the resin 111 in a half-cured state. Additionally, the characteristics of the portion of the resin 111 used as an elastic body can be controlled by controlling the distance between the jig 600 and the base 109 and press-fitting the resin 111 in a half-cured state.

According to the present embodiment, since the hard particles 112 are arranged in the flat friction surface 104 so as to make rows along the direction of sliding between the flat friction surface 104 and the wavelike friction surface 201, and the hard particles 112 are fixed to the flat friction surface, a desired friction material can be manufactured at a comparatively low cost.

Hereinafter, an example of a method for manufacturing the discs 200a to 200g of the above first to seventh embodiments in a ninth embodiment of the invention will be described. For example, if the deviation between the concavo-convex shape of the wavelike friction surface 101 on the pad 100a side and the concavo-convex shape of the wavelike friction surface 201 on the disc 200a side is too large, it is not possible to cope with the deviation in the elastic deformation of the pad 100a and the disc 200a, the contact points between the wavelike friction surfaces 101 and 201 may decrease, and the frictional force may be insufficient.

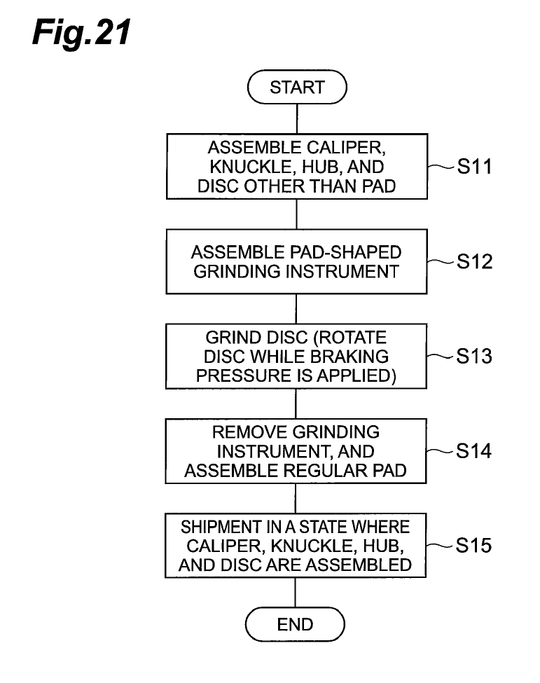

Thus, in the present embodiment, the discs 200a to 200g are manufactured by the following technique. As shown in FIG. 21, the caliper 500c, a knuckle, a hub, and the disc 200a other than the pad 100a are assembled to a suspension of an automobile (S11).

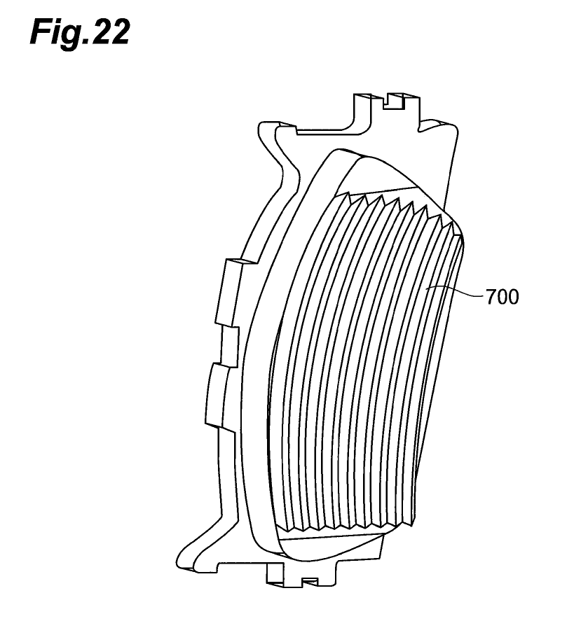

Next, a grinding instrument 700 matched with the shape of the wavelike friction surface 101 of the pad 100a as shown in FIG. 22 is assembled to the part of the pad 100a of the suspension of the automobile (S12). As for the grinding instrument 700, specifically, diamond grinding powder or the like is arranged on the surface of the wavelike friction surface 101 of the pad 100a. Next, as braking pressure is applied to press the grinding instrument 700 against the disc 200a, and the disc 200a is rotated, final grinding of the disc 200a is performed (S13). The grinding instrument 700 is removed and the regular pad 100a is assembled (S14). Shipping is performed in a state where the caliper 500c, a knuckle, a hub, and the disc 200a are assembled (S15).

According to the present embodiment, the grinding instrument 700 capable of grinding the wavelike friction surface 201 of the disc 200a is arranged at the same position as the pad 100a instead of the pad 100a, and the disc 200a is made to slide on the disc 100a along the direction of sliding between the wavelike friction surfaces 101 and 201, thereby grinding the disc 200a with the grinding instrument 700. Therefore, the groove portions of the wavelike friction surface 201 of the disc 200a can be manufactured in the state where the groove portions correspond to the protruding portions of the pad 100a with higher precision. Additionally, the wavelike friction surface 201 of the disc 200a of a customer's automobile can be refreshed by using the grinding instrument 700 in an automobile dealership.

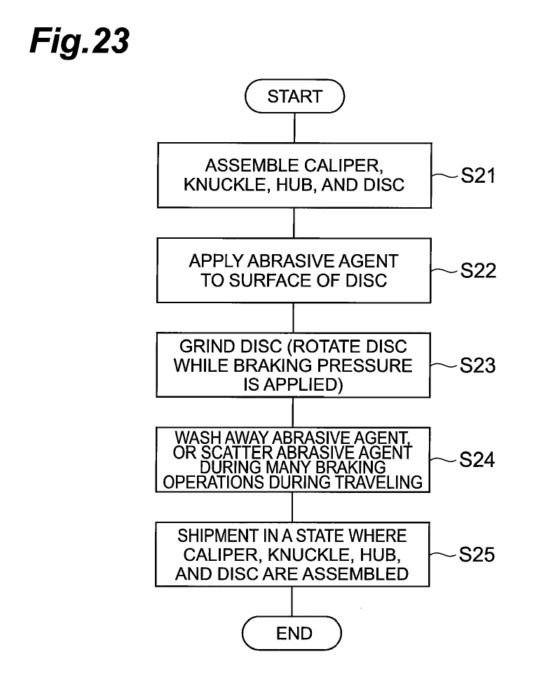

A method for manufacturing the disc 200a of a tenth embodiment also includes the following technique. As shown in FIG. 23, the caliper 500c to which the pad 100a is attached, a knuckle, a hub, and the disc 200a are assembled to a suspension of an automobile (S21). In this case, in an automobile dealership, all of the caliper 500c, the knuckle, the hub, and the disc 200a are already in an assembled state.

Abrasive agent is applied to the wavelike friction surface 201 of the disc 200a (S22). As braking pressure is applied to press the pad 100a against the disc 200a, and the disc 200a is rotated, grinding of the disc 200a is performed (S23). The abrasive agent is washed away, or the abrasive agent is scattered and disappears during multiple braking operations during traveling (S24). In a case where an automobile has not yet been delivered to a selling point, the caliper 500c to which the pad 100a is attached, the knuckle, the hub, and the disc 200a are shipped in the state of being assembled to a suspension of the automobile.

According to the present embodiment, any deviation in irregularities between the wavelike friction surfaces 101 and 201 can be eliminated as final grinding is performed in a state where the caliper 500c to which the pad 100a is attached, the knuckle, the hub, and the disc 200a are assembled to the suspension of the automobile. Additionally, the wavelike friction surface 201 of the disc 200a of a customer's automobile can be refreshed by using in an automobile dealership.

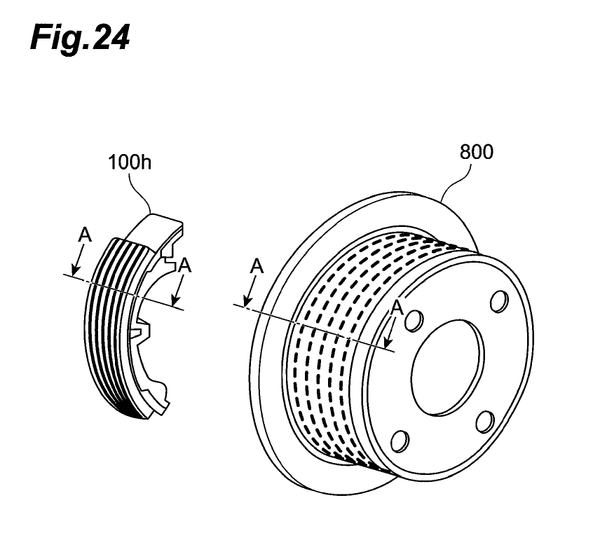

Hereinafter, an eleventh embodiment of the invention will be described. The invention can be applied not only to the disc brakes described in the above first to tenth embodiments but also to a drum brake as shown in FIG. 24. In this case, a braking force is generated as a pad 100h is pressed against the inner surface of a drum 800. The pad 100h and the drum 800 can be formed into a shape shown in FIGS. 2 to 8, 15, and 16 in a sectional view in the line A-A of FIG. 24.

Although the embodiments of the invention have been described above, the invention is not limited to the above embodiments, and various modifications thereof can be made.

### INDUSTRIAL APPLICABILITY

The invention can provide a braking device and a method for manufacturing a friction material which can obtain a higher frictional force, without sacrificing wear resistance.

### REFERENCE SIGNS LIST

10: PAD
20: DISC
100a to 100h: PAD
101: WAVELIKE FRICTION SURFACE
102: HARD PARTICLE
103: HARD LAYER
104: FLAT FRICTION SURFACE
105: R PORTION
106: HOLE
107: APEX PORTION
108a, 108b: SCRAPER
109: BASE
110: GROOVE PORTION
111: RESIN
112: HARD PARTICLE
200a to 200g: DISC
201: WAVELIKE FRICTION SURFACE
203: HARD LAYER
204: FLAT FRICTION SURFACE
205: R PORTION
300: LUBRICANT
400: GRINDING INSTRUMENT
500a, 500b, 500c: CALIPER
501: REACTION FORCE RECEIVING PORTION
502: FLOATING RECEIVING PORTION
600: JIG
700: GRINDING INSTRUMENT
800: DRUM

1. A braking device comprising:
a first friction material having a first hard member on a first friction surface; and
a second friction material having a second hard member on a second friction surface which moves with respect to the first friction surface,
wherein any one of the first hard member and the second hard member includes a groove portion along a movement direction of the second friction surface with respect to the first friction surface,
wherein the other one of the first hard member and the second hard member includes a protruding portion which abuts on the groove portion,
wherein the protruding portion consists of a spherical body and a portion of the spherical body.

2. The braking device according to claim 1,
wherein the groove portion forms a V shape which abuts on the spherical body of the protruding portion at two points, in a sectional view through a section perpendicular to the movement direction of the second friction surface with respect to the first friction surface.

3. The braking device according to claim 1,
wherein any one of the first hard member and the second hard member includes a plurality of the groove portions, and the other one of the first hard member and the second hard member includes protruding portions which abut the plurality of groove portions, respectively.

4. The braking device according to claim 1,
wherein the groove portion and the protruding portion form wavelike shapes which abut on each other, in a sectional view through a section perpendicular to the movement direction of the second friction surface with respect to the first friction surface.

5. The braking device according to claim 4,
wherein the groove portion and the protruding portion form wavelike shapes having mutually different amplitudes, in a sectional view through a section perpendicular to the movement direction of the second friction surface with respect to the first friction surface.

6. (canceled)

7. The braking device according to claim 1,
wherein a force acting on an abutting portion between the grove portion and the protruding portion includes a component in a direction which is perpendicular to the movement direction of the second friction surface with respect to the first friction surface and parallel to either the first friction surface or the second friction surface.

8. The braking device according to claim 1,
wherein as the second friction material rotates, the second friction surface moves with respect to the first friction surface.

9. The braking device according to claim 1,
wherein at least any one of the first hard member and the second hard member includes a foreign matter removing portion which discharges foreign matter which has entered between the groove portion and a recessed portion.

10. The braking device according to claim 1,
wherein the first hard member and the second hard member are made of any of a material of a hardness at which wear does not occur when the second friction surface moves with respect to the first friction surface and a material with a Mohs hardness which is greater than or equal to 9.

11. The braking device according to claim 1,
wherein the first hard member and the second hard member are made of any of the same material and materials having the same Mohs hardness.

12. A method for manufacturing a first friction material in a friction material for braking including the first friction material having a first hard member on a first friction surface; and a second friction material having a second hard member on a second friction surface which moves with respect to the first friction surface, the second hard member including a groove portion along a movement direction of the second friction surface with respect to the first friction surface, and the first hard member including a protruding portion which abuts on the groove portion, the method comprising:
arranging spherical hard members on the first friction surface so as to make rows along the movement direction of the second friction surface with respect to the first friction surface; and
fixing the hard member to the first friction surface.

13. A method for manufacturing a second friction material in a friction material for braking including a first friction material having a first hard member on a first friction surface; and the second friction material having a second hard member on a second friction surface which moves with respect to the first friction surface, the second hard member including a groove portion along a movement direction of the second friction surface with respect to the first friction surface, and the first hard member including a protruding portion which abuts on the groove portion, the method comprising:
arranging a grinding member capable of grinding the second hard member at the same position as the protruding portion of the first friction material instead of the protruding portion of the first friction material; and
moving the second friction surface with respect to the first friction surface along a movement direction of the second friction surface with respect to the first friction surface, thereby grinding the second hard member with the grinding member.
